(19) United States
(12) Patent Application Publication
(10) Pub. No.: US 2005/0168338 A1
(43) Pub. Date: Aug. 4, 2005

(54) Article locator apparatus with remote tokens

(75) Inventors: Andrew J. Parker, Novato, CA (US); Shek Fai Lau, Foster City, CA (US)

Correspondence Address: FLIESLER MEYER, LLP, FOUR EMBARCADERO CENTER, SUITE 400, SAN FRANCISCO, CA, 94111, US

(73) Assignee: Sharper Image Corporation, San Francisco, CA (US)

(21) Appl. No.: 11/003,057

(22) Filed: Dec. 3, 2004

Related U.S. Application Data
(60) Provisional application No. 60/532,149, filed on Dec. 22, 2003.

(51) Int. Cl. G08B 1/08

(52) U.S. Cl. 340/539.32

(57) ABSTRACT

An apparatus for assisting in the location of lost or misplaced objects. Receivers are coupled to objects that are likely to be misplaced. The pager device sends a signal to a select one of a number of receivers which then can emit an audible multi-frequency sound and/or emit light. In one embodiment, the audible sound is comprised of two asynchronous interlaced tones, much like an ambulance siren, one in a high frequency range and one in a low frequency range.

### RELATED APPLICATIONS

This Patent Application claims priority under 35 U.S.C. 119 (e) of the co-pending U.S. Provisional Patent Application Ser. No. 60/532,149 entitled, “ARTICLE LOCATOR APPARATUS WITH REMOTE TOKENS” by Andrew Parker et al., filed Dec. 22, 2003 (Attorney Docket No. SHPR-01418US0) which is hereby incorporated by reference.

### FIELD OF THE INVENTION

The present invention relates generally to an apparatus for assisting in the location of a lost or misplaced object.

### BACKGROUND OF THE INVENTION

In recent years, advances in technology have allowed manufacturers of various devices and objects to make their devices and objects smaller and smaller. While smaller devices are often more convenient, when the devices and objects are lost or misplaced, locating these devices and objects is oftentimes difficult, frustrating and many times impossible. Consequently, owners of these devices and objects oftentimes give up searching for the devices and simply electing to replace them rather than continue searching for the missing device or object. Over the years, various devices have been developed to assist in the location of objects which have various advantages and shortcomings.

U.S. Pat. No. 4,507,653, issued on Mar. 26, 1985, to Bayer, describes an object finder device which can be mounted on a personal item. The device responds to a predetermined sound such as hand clapping, whistling, and the like by producing an audible signal. The effectiveness of this device is limited to the range where the designated sound reaches a threshold level and can be heard.

U.S. Pat. No. 4,558,307, issued Dec. 10, 1985, to Lienart van Lidt de Jeude, describes a light-actuated reminder device which attaches to keys, a wallet or a diary, and the like which would normally be left in a pocket or cabinet where light is absent. Upon exposure to light for a predetermined time, an alarm within the device sounds. A cover is provided for placement over the device sensor when not in operation. This system is impractical in that the device may be left in an area where light will not commonly reach, such as behind a couch. Also, the item could be left at a location with the cover on, resulting in inoperativeness of the system and loss of the item.

U.S. Pat. No. 5,598,143, issued on Jan. 28, 1997, to Wentz, describes a device for mounting in a location, such as near a television. The device selectively signals a plurality of control devices, known as beepers, upon actuation to activate a sound signal from each selected control device to disclose their location. This system does not provide for the location of any personal items, but only to remote control devices.

U.S. Pat. No. 5,629,677, issued on May 13, 1997, to Staino, Jr. describes a locator system particularly designed for eyeglasses. The eyeglass holder acts as the finding device and signals are transmitted from the holder to a device on the eyeglasses which emits an audible signal upon manual activation of the combination holder and finding device. This system is practically confined to eyeglasses and is not appropriate for use with any other personal items which are subject to loss.

U.S. Pat. No. 5,638,050, issued on Jun. 10, 1997, to Sacca et al., describes a finding device primarily used for the location of a television remote control. The primary novelty apparent in Sacca is the reduced power consumption of the receiver which activates an audible signaling device. However, this system is not amenable to finding a variety of discreet personal items. The finding device is also subject to being mislaid, thus prejudicing the reliability of the locator system.

U.S. Pat. No. 5,673,023, issued Sep. 30, 1997, to Smith, describes a locating system primarily designed for locating a remote control unit for a television, etc. which employs both light signaling and simulated speech sound signaling at the receiver portion, which is located on one of the respective remote control units. This system is practical for finding small objects such as keys or wallets, etc.

U.S. Pat. No. 5,677,673, issued Oct. 14, 1997, to Kipnis describes a wall-mounted personal item locator unit which has a plurality of labeled buttons which correspond to receiver units mountable on objects subject to loss. Each mountable receiver unit emits a characteristic sound such that upon activation of the item locator unit, the desired object is found by listening for its sound emission. An alternative system employs a transportable transmitter unit. The transmitter continually transmits an activation signal intermittently upon actuation. The selected receiver unit then sends a signal back to the transmitter thereby activating a flashing light such as a light-emitting diode (LED). As the user approaches the lost item, the rate of flashing increases. This light-emitting mode is used in addition to the sound-emitting device on the receiver. This system is of limited usefulness in the wall-mounted embodiment due to necessarily limited range. In the case of the portable locator, the locating device is itself subject to loss, thus compromising the system's overall reliability.

U.S. Pat. No. 5,680,105, issued Oct. 21, 1997, to Hedric describes a locating device for locating household objects by means of matching coded senders and receivers mounted on a rack when not in use. The elements for attachment are coded to respond to a multiplicity of corresponding individual finders. This system suffers from a design having a large number of parts which are subject to loss. The cost of having individual finders with separate circuits results in an unduly expensive locator system. The elements for attachment are relatively large and would not be appropriate for small objects such as key chains.

While the above-described devices are useful for the casual user, they provide little or no assistance to the hearing or visually impaired. What is needed is a locator device that offers assistance to the hearing or visually impaired in locating objects.

### SUMMARY OF THE INVENTION

Embodiments of the present invention are directed to an article locator device with remote tokens for locating a plurality of articles to which each token is attached.

Other features and advantages of the present invention will become apparent after reviewing the detailed description of the preferred and alternative embodiments set forth below.

### BRIEF DESCRIPTION OF THE DRAWINGS

FIG. 1 is an isometric view of the front side of a locator pager device in accordance with the present invention.

FIG. 2 is an isometric view of the back side of the locator pager device in accordance with the present invention.

FIG. 3 is an isometric view of a mounting bracket for the locator pager device in accordance with the present invention.

FIGS. 4A and 4B are front and back side views of a receiver in accordance with the present invention.

FIG. 5 is a top view of the receiver shown in FIG. 4A with the front identifying plate removed in accordance with the present invention.

### DETAILED DESCRIPTION OF THE PRESENT INVENTION

One aspect of the present invention is directed to an object locator system which comprises a transmitter that is capable of transmitting a plurality of signals. The system comprises a plurality of receivers, whereby each receiver is capable of being attached to an object. One receiver of the plurality emits a multi-frequency tone upon receiving a unique signal of the plurality of the signals transmitted by the transmitter.

Another aspect of the present invention is directed to an object locator system which comprises a plurality of receiver units. Each receiver unit comprises a first housing which is adapted to couple to an object as well as a light source that is configured to emit a first visual signal. Each receiver unit also comprises a speaker that is configured to emit a first audio signal upon receipt of an activation signal which is unique to the receiver unit. The system also includes a transmitter unit which comprises a second housing which has a plurality of buttons and a transmitter which is coupled to the buttons. The transmitter is configured to transmit the activation signal which is unique to a corresponding receiver unit upon depressing a corresponding button.

Another aspect of the invention is directed to a method of locating objects which comprises coupling a receiver to an object. The method also comprises transmitting a unique signal from a transmitter that is configured to produce a plurality of signals. The method comprises emitting a multi-frequency audio signal from the receiver upon receipt of the unique signal.

The above mentioned aspects of the present invention preferably and alternatively include additional aspects and features as follows. The multi-frequency tone further comprises at least two asynchronous periodic interlaced tones which are selected from the frequency range from and including approximately 0 Hz to approximately 10,000 Hz and alternatively 10,000 Hz to approximately 20,000 Hz. Alternatively, the multi-frequency tone is comprised of at least two synchronous tones, whereby the tones are periodic or continuous.

In the above aspects, the receiver is configured to emit light upon receiving the unique signal, which can be either continuous or periodic. The invention further comprises a bracket that is detachably coupled to the transmitter. The transmitter further comprises at least one speaker configured to emit a sound, preferably when the transmitter is detached from the bracket after a predetermined amount of time. In one embodiment, the sound is a multi-frequency tone comprised of at least two asynchronous periodic interlaced tones selected from the frequency range from and including approximately 0 Hz to approximately 10,000 Hz, or alternatively 10,000 Hz to approximately 20,000 Hz. The multi-frequency tone is alternatively comprised of at least two synchronous tones, which can be periodic or continuous. In another embodiment, the transmitter further comprises one or more light sources which are configured to emit light when the transmitter is detached from the bracket. The receiver further comprises one or more light sources which are configured to emit light upon receiving the unique signal.

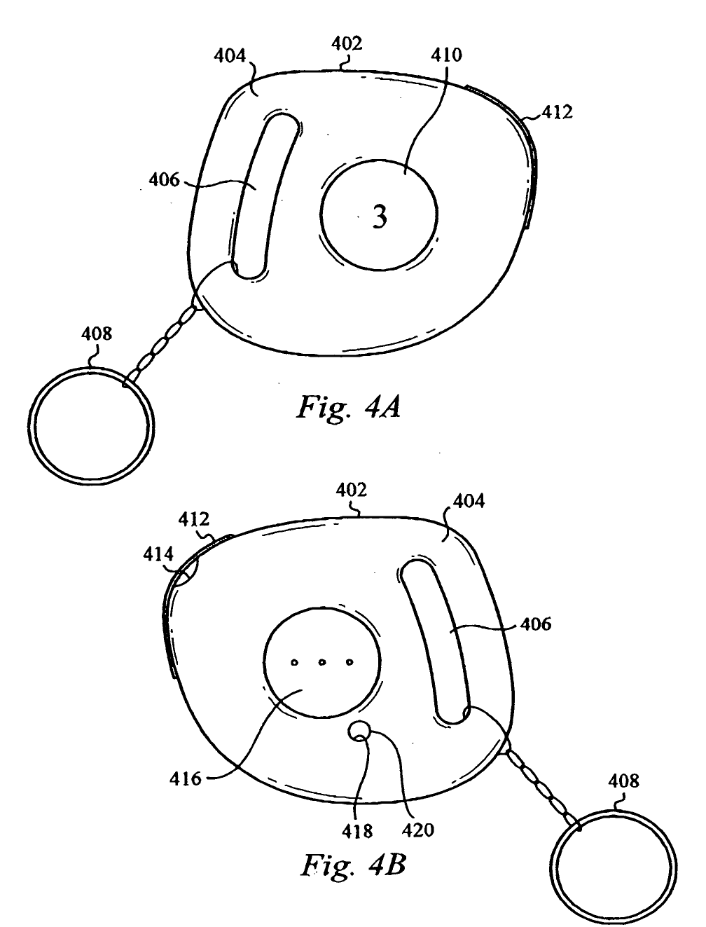

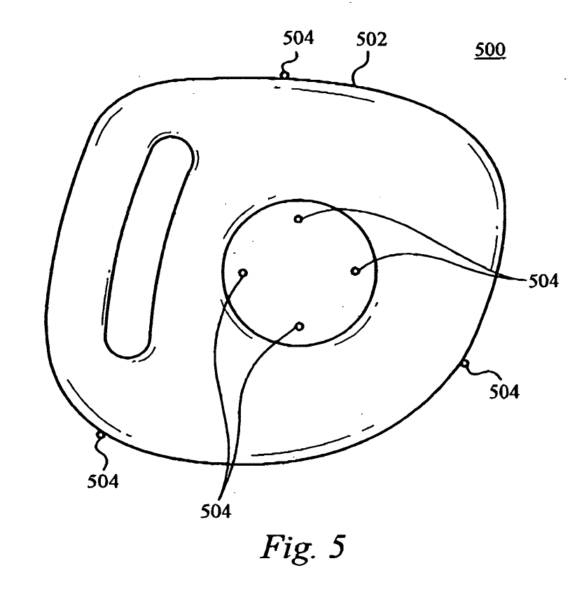

The present invention is directed to a locator pager device 100 for finding misplaced and/or lost objects, such as keys, a television/VCR remote control, a pager, a cellular phone or wallet and the like. The present invention also includes a plurality of receivers 402 (FIGS. 4-5) which are preferably coupled to a particular object that is to be located. In operation, the pager device 100 sends a signal to a selected one of a plurality of receivers 402 that emits an audible tone and/or light upon activation by the signal.

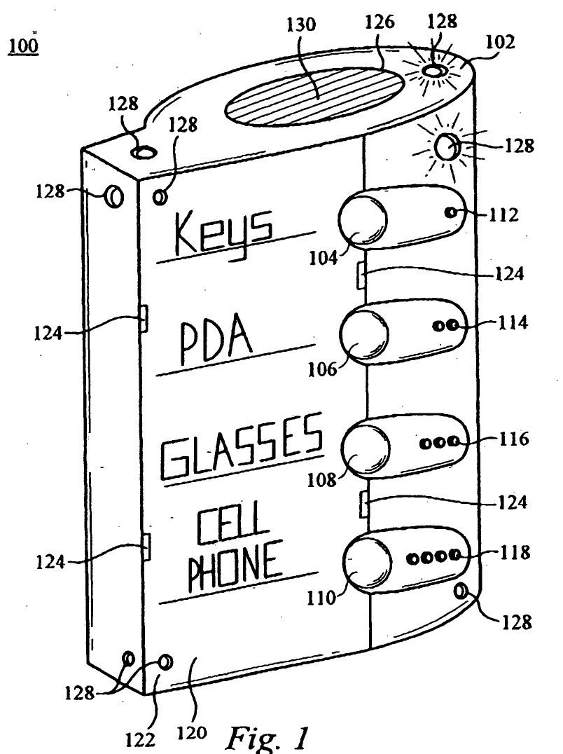

FIG. 1 illustrates the front side of a locator pager device 100. In the preferred embodiment, the pager device 100 preferably includes a casing or body 102 and four buttons 104, 106, 108, 110 protruding from the casing 102. Alternatively, the device 100 alternatively includes any number of buttons. The device 100 includes a power supply (not shown) as well as a transmitter circuit (not shown) within. The power supply and transmitter (not shown) are coupled to each of the buttons 104, 106, 108, 110.

In the embodiment shown in FIG. 1, the casing 102 is preferably made of an opaque plastic. Alternatively, the casing 102 is made of any other appropriate material. In the embodiment shown in FIG. 1, each of the four buttons 104, 106, 108, 110 is associated with a respective receiver 402 (FIG. 4A). Although the buttons 104, 106, 108, 110 are shown as having a circular shape, each button alternatively have a unique shape and/or number to facilitate identification. In another embodiment, the buttons are color coded to identify the button with its assigned receiver 402 (FIG. 4A).

In one embodiment, the casing 102 includes four unique braille indicator markings 112, 114, 116, 118 disposed thereon, whereby each marking corresponds to a button. Thus, marking 112 corresponds to button 104, marking 114 corresponds to button 106, marking 116 corresponds to the button 108, and marking 118 corresponds to button 110. It is preferred that the markings are correspondingly also located on each token 402 (FIG. 4), as is discussed below. The markings can aid a visually impaired user to identify which button she is depressing. Alternatively, the indicator markings 112, 114, 116, 118 are configured any other appropriate way to differentiate the buttons by touch. Alternatively, the unique Braille indicator markings are not present on the casing 102.

In the embodiment shown in FIG. 1, the casing 102 preferably includes an identification label 120 positioned below a protective barrier 122. The identification label 120 allows the user to write the name of the article next to the button which corresponds to locating that article. As shown in FIG. 1, the button 104 corresponds to the writing, “Keys”, whereas the button 106 corresponds to the writing, “PDA”, and so on. Alternatively, the identification label 120 allows the user to write the place a picture or sticker of the article next to the button which corresponds to locating that article. The identification label 120 is made of any convenient material and preferably has an adhesive backing. In the embodiment shown in FIG. 1, the identification label 120 is preferably made of heavy stock paper. In the preferred embodiment, the protective barrier 122 is made of a plastic which is at least partially transparent to allow the user to view the writing associated with each button. Alternatively, the protective barrier 122 is made of any other material. The protective barrier 122 is preferably removably coupled to the casing 102 at points 124 by any appropriate manner or method. Alternatively, the protective barrier 122 is not present in the device 100.

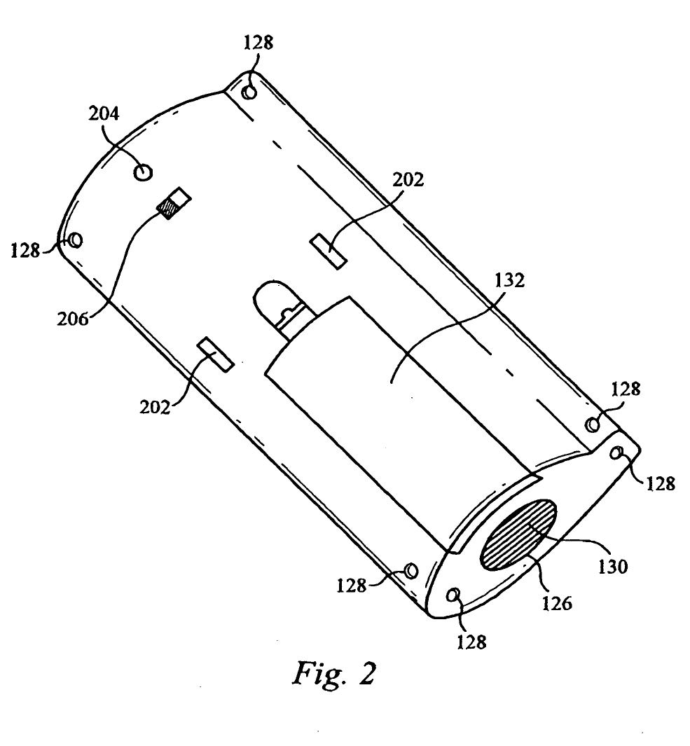

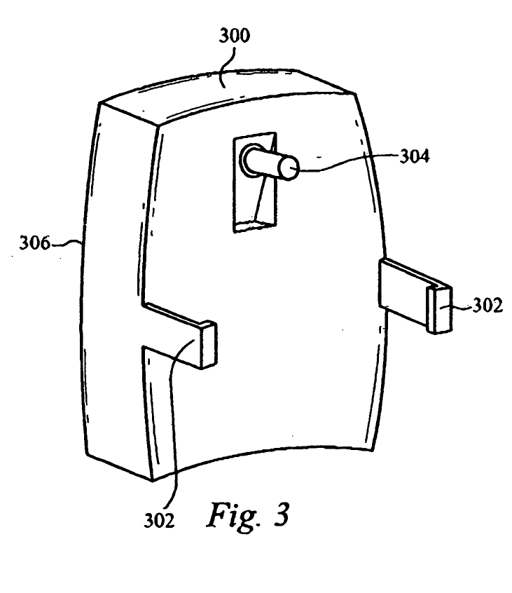

In the embodiment shown in FIG. 1, the casing 102 preferably includes a speaker opening 126 and/or numerous light sources 128. The casing 102 preferably includes a single speaker 130 within and a speaker opening 126 located along one or more surfaces of the casing 102. For instance, the device 100 includes a speaker 130 on its top surface, as shown in FIG. 1, as well as its bottom surface, as shown in FIG. 2. The speaker 130 as well as the light sources 128 are coupled to the power source (not shown). The speaker 130 located inside the casing 100 is designed to emit one or more audible signals when the casing 100 is separated from a bracket (300, FIG. 3) for a predetermined amount of time. The bracket (FIG. 3) is discussed in more detail below.

In the embodiment shown in FIGS. 1 and 2, the speaker 120 is preferably configured to emit a single-tone or multi-tone frequency sound. The single-tone is a tone preferably selected from the frequency range of approximately 0 Hz to 20,000 Hz. In one embodiment, the multi-tone frequency includes one high-frequency audible tone and one low-frequency audible tone. The two tones are emitted sequentially in an interlaced fashion such that at any given time, the speaker 130 is either emitting a low-frequency tone or a high-frequency tone, such as an effect similar to an ambulance siren. The high-frequency tone is a tone preferably selected from the frequency range of approximately 10,000 Hz to approximately 20,000 Hz. The low frequency tone is a tone preferably selected from the frequency range of approximately 0 Hz to 10,000 Hz. However, in alternate embodiments, the high and low frequency tones are selected from any other range within the audible frequency spectrum. Alternatively, the tones are synchronous or asynchronous to one another. The multi-frequency tones are emitted periodically to assist the user to locate the device 100 when the device 100 is removed from the bracket 300 after a certain amount of time. In addition, the tone difference in multi-frequency tones, such as a two tone sound, would aid a user who is hard of hearing in finding the device 100. Thus, this feature of the present invention is helpful to users who are visually and/or hearing impaired.

In the embodiment shown in FIG. 1, the casing 102 preferably includes a set of light sources 128 at each of the corners of the casing 102. In one embodiment, the light sources 128 are all of the same size. In another embodiment, the light sources 128 are of different sizes, as shown in FIG. 1. The light sources 128 preferably brightly flash, when activated, to aid the user in finding the device 100. The light sources are preferably red light emitting diodes (LEDs). Alternatively, any other appropriate light source of any color is used. Alternatively, the light sources 128 are located anywhere on each surface of the casing 102. In the embodiment shown in FIG. 1, the light sources 128 are designed to periodically or constantly emit light when the casing 102 is separated from the bracket (300, FIG. 3) after a certain time. This feature is especially helpful to a user who is hearing impaired.

FIG. 2 shows the back side of the locator pager device 100 shown in FIG. 1. In the embodiment shown in FIG. 2, the casing 102 includes a battery compartment and door 132, two mounting slots 202, a recess 204 and a switch 206. The battery compartment 132 houses the batteries which power the device 100. The power source (not shown) is preferably an alkali battery, although any other known power source is alternatively used. Although it is preferred to power the device 100 using a DC power source, the device 100 alternatively/additionally is powered by an AC power source. The mounting slots 202 are designed to detachably couple to the extensions (302, FIG. 3) associated with the bracket (300, FIG. 3). The recess 204 is designed to detachably couple to a corresponding protrusion (304, FIG. 3) associated with the bracket (300, FIG. 3). Although the mounting slots 202 and the recess 204 are shown in a specific configuration in FIG. 2, the location and number of slots 202 and/or recess(es) 204 alternatively vary.

The switch 206 is coupled to the power source (not shown) as well as the light sources 128 and the speaker 126. The switch 206 located on the back of the pager device 100 is preferably able to be set to one of four positions or settings: “Off”, “Light”, “Sound”, and “Light & Sound”. The different settings allow the user to easily locate the locator device 100 in the event that the locator device 100 is removed from the bracket 300 (FIG. 3). It is preferred that the device 100 includes a circuit within which is configured to automatically activate the light sources 128 and/or speaker 126 when the protrusion 304 (FIG. 3) is removed from the recess 204 and/or the extensions 302 (FIG. 3) are removed from the slots 202 for a predetermined amount of time. The specifics of such a circuit is well known in the art and is not discussed in detail herein.

When the switch 206 is in the “Off” position, the pager device 100 will not emit any light or sound when disengaged from the bracket (300, FIG. 3). When the switch 206 is in the “Light” position, the light sources 128 on the pager device 100 preferably illuminates periodically, cyclically, continuously, or in any other pattern to assist the user in locating the pager device 100. When the switch 206 is in the “Sound” position, the speaker 130 emits a periodically repeating audible sound to assist the user in locating the pager device 100. When the switch 206 is in the “Light & Sound” position, the light sources 128 illuminate and the speaker 120 emits an audible sound to assist the user in locating the pager device 100.

FIG. 3 shows a perspective view of a bracket 300 to which the pager device 100 (FIG. 1) is preferably coupled. The bracket 300 preferably includes one or more extensions 302 that are designed to be inserted into the slots 202 in the back of the pager device 100 and a protrusion 304 which is designed to be inserted into the recess 204 in the back of the pager device 100. In the embodiment shown in FIG. 3, the extensions 302 are shown having a rectangular shape and the protrusion 304 is shown having a cylindrical shape which correspond with the slots 202 and recess 204 of the device 100, respectively (FIG. 2). Alternatively, the extensions 302 and the protrusion 304 have any other appropriate shape. In an alternate embodiment, the bracket includes any number of extensions 302 and protrusions 304 located in any appropriate location on the bracket 300 as long as the extension 302 and the protrusion 304 are positioned to couple to the respective receiving features of the locator device 100. The locator device 100 is preferably decoupled from the bracket 300 by simply pulling the device 100 away from the bracket 300. It is apparent to one skilled in the art that any other convenient and/or known mechanism is alternatively used to detach the pager device 100 from the bracket 300. The circuit (not shown) within the device 100 is automatically activated to cause the device 100 to periodically emit light and/or sounds once the protrusion 304 and/or extensions 302 are removed from the recess 204 and slots 202, respectively.

In the embodiment shown in FIG. 3, the bracket 300 includes a feature for coupling the bracket 300 to a surface. Preferably, the feature is a magnetic strip that is adhered to the back side 306 of the bracket 300, whereby the bracket 300 is able to be coupled to a metallic surface, such as a refrigerator. An adhesive is alternatively applied to the back side 306 of the bracket 300. Alternatively, any other known appropriate mechanism is contemplated to couple the bracket 300 to a surface. It is contemplated by one skilled in the art that the bracket 300 alternatively includes a clip (not shown) for securing the bracket 300 to a person's clothing, such that the user can wear the bracket 300 and locator 100 on her waist or on a belt strap.

The pager 100 includes an emitter circuit (not shown) within, whereby the emitter circuit (not shown) is coupled to the power source (not shown) as well as the individual buttons 104, 106, 108, 110. The emitter circuit (not shown) includes a transmitter (not shown) which transmits a search signal uniquely associated with each one of the buttons 104, 106, 108, 110. Each unique search signal activates a corresponding receiving circuit (not shown) in the receiver 402 which is programmed to activate upon receiving the unique search signal from the pager 100. For example, button 104 when depressed will cause the transmitter (not shown) in the pager 100 to emit a search signal for the receiver 402 assigned to button 104. If the search signal reaches the receiving circuit (not shown) of the assigned receiver 402, the assigned receiver 402 will activate by emitting a sound and/or a light to aid the user in locating the receiver 402 and the object attached thereto. The search signal is preferably a Radio Frequency signal, although any other appropriate communication technique is alternatively contemplated.

FIGS. 4A and 4B illustrate the front and back sides of a receiver or locator 402, respectively. As stated above, each receiver 402 is designed to operate when its corresponding button on the pager 100 is depressed. Each receiver's housing 402 preferably has a unique color associated with a button 104, 106, 108, 110 on the pager device 100 to allow the user to identify the receiver 402 with the particular button. Alternatively, the housing 402 has a unique shape associated with a corresponding button or braille marking on the locator device 100.

The receiver 402 preferably includes a housing 404 which has an opening 406 which extends completely through the housing 404. The opening 406 allows an attachment ring 408 to be coupled to the receiver 402. In an alternate embodiment, the receiver 402 does not include an opening 406. The attachment ring 408 shown in FIG. 4A includes a chain with removable rings. The attachment ring 408 attaches to an object which the user wants to locate using the present device 100. In one embodiment, the attachment ring 408 operates like a key ring. The attachment ring 408 is alternatively any other appropriate mechanism. In an alternate embodiment, the receiver 402 does not utilize an attachment ring 408, whereby the receiver 402 is able to be attached to an object by an adhesive, magnetic or in any other appropriate manner.

In the embodiment shown in FIG. 4A, the receiver 402 preferably includes an identifier 410 which identifies the particular button on the locator 100 which the receiver 402 is associated with. It is preferred that the receiver 402 includes a unique braille indicator marking 416 which corresponds to the unique braille marking on the pager device 100, as shown in FIG. 4B. For instance, the receiver 402 shown in FIG. 4B includes 3 braille markings 416 which corresponds to button 108 on the locator 100 having three braille markings 116 (FIG. 1). Alternatively, the receiver 402 includes a transparent plastic cover 410 that is removably coupled to the housing 404, whereby a sticker or piece of paper is able to be inserted under the plastic cover 410 to identify the receiver 402 with its unique assigned button on the locator device 100. In another embodiment, the identifier 410 is embossed in the housing or affixed in any alternative manner.

The receiver 402 preferably also includes a removable battery cover 412 as shown in FIGS. 4A and 4B. The battery cover 412 is removable such that the power source (not shown) for the receiver 402 is able to be easily replaced. The power source (not shown) is preferably an alkali battery, although any other known power source is alternatively used. FIG. 4B illustrates the opposite side of the receiver 402 shown in FIG. 4A. In the embodiment shown in FIG. 4B, the casing 404 has a depression 414 to facilitate the removal of the battery cover 412. Alternatively, the depression 414 is not present on the receiver 402.

Preferably the receiver 402 includes an opening 418 with a speaker 420 located therein. In one embodiment, the speaker 420 emits a single tone frequency when activated. In an alternative embodiment, the speaker 420 emits a multi-tone frequency which includes one high-frequency audible tone and one low-frequency audible tone when activated. The two tones are emitted sequentially in an interlaced fashion such that at any given time, the speaker 420 is either emitting a low-frequency tone or a high-frequency tone. The high-frequency tone is selected from the frequency range of approximately 10,000 Hz to approximately 20,000 Hz. The low-frequency tone is selected from the frequency range of approximately 0 Hz to 10,000 Hz. Alternatively, the high and low frequency tones are selected from any range within the audible frequency spectrum. Alternatively, the two frequency tones are superimposed onto each other. In another embodiment, the tones are synchronous or asynchronous with one another. In one embodiment, each receiver 402 emits the same multi-frequency tone. In another embodiment, each receiver 402 emits a different multi-frequency tone. In addition, the tone difference in multi-frequency tones, such as a two tone sound, would aid a user who is hard of hearing in finding the receiver 402. Thus, this feature of the present invention is helpful to users who are visually and/or hearing impaired.

FIG. 5 illustrates an alternate embodiment of the receiver 500. In the alternative embodiment shown in FIG. 5, the receiver 500 includes one or more light sources 504 located on the housing 502 which illuminate bright flashes when the receiver 402 is activated by the pager device 100. The light sources 504 assist the a user in locating the receiver 402 and the associated object to which the receiver 402 is coupled when activated. Although four light sources 502 are shown behind the plastic cover, any number of light sources are contemplated. In addition, it is contemplated that the light sources 502 are located elsewhere on the receiver 400, such as on the outer surface of the receiver 402 as shown in FIG. 5. The light sources are preferably red light-emitting diodes (LEDs). Alternatively, any other convenient color and/or light source is used. This feature of the receiver 402 is helpful to users who are visually and/or hearing impaired.

Each receiver 402 includes a receiver circuit (not shown) within which is coupled to the power source (not shown) as well as the speaker 420 and/or the light sources 502. The receiver circuit (not shown) includes a receiving element (not shown) which activates the speaker 420 and/or light sources 502 upon receiving a search signal sent by the pager device 100 which is unique to that receiver. As stated above, the search signal is preferably a Radio Frequency signal, although other communication techniques are contemplated. The receiving element (not shown) is configured to respond to a particular assigned signal frequency emitted from the pager device 100. Therefore, the receiving element (not shown) will not activate the speaker 420 and/or light sources 502 until it receives its assigned signal from the pager device 100. This allows the pager device 100 to emit one search signal without activating all of the other receivers 402. In one embodiment, the receiving element (not shown) is assigned its assigned search frequency by the manufacturer. In another embodiment, the receiving element (not shown) is assigned its assigned search frequency by the user.

In operation, the user couples one of the receivers 402 to one object which she would like to later locate. The user preferably performs the same process with the remaining receivers and other objects. The user then preferably writes the name of the object or places a picture of the object on the identification label 120 and places it under the protective barrier 122 next to the button which is assigned to the receiver 402 that is coupled to that object. Preferably the color of the button is the same as the color of the receiver 402, although it is not necessary. For example, if the user is trying to locate a set of keys (FIG. 1), the user depresses button 104.

Upon depressing the button 104, the transmitter (not shown) within the which transmits a search signal uniquely associated the button 104. If the search signal reaches the receiving circuit (not shown) of the receiver 402 associated with button 104, the receiving circuit will activate the speaker 420 and/or light source 504. It should be noted that the search signal transmitted by the pager 100 will not activate the receivers 402 associated with buttons 106, 108 and 110 due to the unique search signal.

While the system has been described with reference to specific embodiments, this description is not intended to be construed in a limiting sense. Various modifications of the disclosed embodiments, as well as other embodiments, will be apparent to persons skilled in the art upon reference to this description. It is therefore contemplated that the appended claims will cover any such modification or embodiments as fall within the true scope of the system described herein.

1. An object locator system comprising:
a. a transmitter capable of transmitting a plurality of signals; and
b. a plurality of receivers, each receiver capable of being attached to an object, wherein one receiver of the plurality emits a multi-frequency tone upon receiving a unique signal of the plurality of the signals.

2. The object locator system of claim 1 wherein the multi-frequency tone is comprised of at least two periodic interlaced tones.

3. The object locator system of claim 2 wherein the periodic interlaced tones are asynchronous with one another.

4. The object locator system of claim 2 wherein the periodic interlaced tones are selected from the frequency range from and including approximately 10,000 Hz to approximately 20,000 Hz.

5. The object locator system of claim 2 wherein at least one of the asynchronous periodic interlaced tones is selected from the frequency range from and including approximately 0 Hz to approximately 10,000 Hz.

6. The object locator system of claim 1 wherein the multi-frequency tone is comprised of at least two tones.

7. The object locator system of claim 6 wherein the tones are synchronous with one another.

8. The object locator system of claim 6 wherein the tones are periodic.

9. The object locator system of claim 8 wherein the tones are continuous.

10. The object locator system of claim 1 wherein each receiver further comprises at least one light source configured to emit light upon receiving the unique signal.

11. The object locator system of claim 1 wherein the light source emits at least one of a continuous light and a periodic light upon receiving the unique signal.

12. The object locator system of claim 1 further comprising a bracket configured to be coupled to a surface, wherein the transmitter is detachably coupled to the bracket.

13. The object locator system of claim 12 wherein the transmitter further comprises at least one speaker configured to emit an audible signal.

14. The object locator system of claim 13 wherein the transmitter emits the audible signal when detached from the bracket.

15. The object locator system of claim 13 wherein the transmitter emits the audible signal when detached from the bracket after a predetermined amount of time.

16. The object locator system of claim 11 wherein the audible signal is a multi-frequency audible signal.

17. The object locator system of claim 16 wherein the multi-frequency audible signal is comprised of at least two asynchronous periodic interlaced audible signals.

18. The object locator system of claim 17 wherein at least one of the asynchronous periodic interlaced audible signals is selected from the frequency range from and including approximately 0 Hz to approximately 10,000 Hz.

19. The object locator system of claim 17 wherein at least one of the asynchronous periodic interlaced audible signals is selected from the frequency range from and including approximately 10,000 Hz to approximately 20,000 Hz.

20. The object locator system of claim 16 wherein the multi-frequency audible signal is comprised of at least two synchronous audible signals.

21. The object locator system of claim 16 wherein the synchronous audible signals are periodic.

22. The object locator system of claim 16 wherein the synchronous audible signals are continuous.

23. The object locator system of claim 13 wherein the transmitter further comprises one or more light sources configured to emit light when the transmitter is detached from the bracket.

24. An object locator system comprising:
a. a plurality of receiver units, each comprising:
i. a first housing adapted to couple to an object
ii. at least one light source configured to emit a first visual signal upon receipt of an activation signal unique to the receiver unit; and
iii. a speaker configured to emit at least one tone upon receipt of the activation signal; and
b. a transmitter unit comprising:
i. a second housing having a plurality of buttons; and
ii. a transmitter circuit coupled to the buttons, the transmitter circuit configured to transmit the activation signal unique to a corresponding receiver unit upon depressing a corresponding button.

25. The object locator system of claim 24 further comprising a bracket configured to be coupled to a surface, wherein the transmitter is detachably coupled to the bracket.

26. The object locator system of claim 25 wherein the transmitter unit further comprises:
a. a transmitter speaker capable of emitting an audible signal when the transmitter unit is detached from the bracket; and
b. at least one transmitter light source capable of emitting a second visual signal when the transmitter unit is detached from the bracket.

27. The object locator system of claim 24 wherein the at least one tone further comprises a multi-frequency tone having at least two periodic asynchronous interlaced tones.

28. The object locator system of claim 24 wherein the at least one tone further comprises a multi-frequency tone having at least two periodic synchronous interlaced tones.

29. The object locator system of claim 24 wherein the first tone further comprises a multi-frequency tone having at least one continuous tone and at least one periodic tone.

30. The object locator system of claim 24 wherein the first visual signal is one of a periodic visual signal and a continuous light signal.

31. The object locator system of claim 26 wherein the transmitter unit further comprises a switch configured to selectively control at least one of the transmitter speaker and the transmitter light source.

32. The object locator system of claim 26 wherein the audible signal is a multi-frequency audible signal.

33. The object locator system of claim 32 wherein the multi-frequency audible signal further comprises at least two periodic asynchronous interlaced audible signals.

34. The object locator system of claim 32 wherein the multi-frequency audible signal further comprises at least two periodic synchronous audible signals.

35. The object locator system of claim 32 wherein the multi-frequency audible signal further comprises at least one of a continuous audible signal and a periodic audible signal.

36. A method of locating objects comprising:
a. coupling a receiver to an object;
b. transmitting a unique signal from a transmitter configured to produce a plurality of signals; and
c. emitting a multi-frequency tone from the receiver upon receipt of the unique signal.

37. The method of claim 36 wherein the multi-frequency tone further comprises at least two periodic asynchronous interlaced tones.

38. The method of claim 36 wherein the multi-frequency tone further comprises at least two synchronous tones.

39. The method of claim 36 wherein the multi-frequency tone further comprises at least one of a continuous tone and a periodic tone.

40. The method of claim 36 wherein the multi-frequency tone signal further comprised at least two continuous tones of different frequencies.

41. The method of claim 37 wherein at least one of the periodic asynchronous interlaced tones is selected from the frequency range from and including approximately 10,000 Hz to approximately 20,000 Hz.

42. The method of claim 37 wherein at least one of the periodic asynchronous interlaced tones is selected from the frequency range from and including approximately 0 Hz to approximately 10,000 Hz.

43. The method of claim 37 wherein the synchronous tones are periodic.

44. The method of claim 37 wherein the synchronous tones are continuous.

45. The method of claim 36 wherein each receiver is configured to emit light upon receiving the unique signal.

46. The method of claim 36 further comprising emitting a visual signal upon receiving the unique signal.

47. The method of claim 36 further comprising emitting an audible signal from the transmitter when detached from a bracket after a predetermined amount of time.

48. The method of claim 47 wherein the audible signal is a multi-frequency audible signal.

49. The method of claim 47 wherein the multi-frequency audible signal further comprises at least two asynchronous periodic interlaced audible signals.

50. The method of claim 49 wherein at least one of the asynchronous periodic interlaced audible signals is selected from the frequency range from and including approximately 0 Hz to approximately 10,000 Hz.

51. The method of claim 49 wherein at least one of the asynchronous periodic interlaced audible signals is selected from the frequency range from and including approximately 10,000 Hz to approximately 20,000 Hz.

52. The method of claim 47 wherein the multi-frequency audible signals further comprises at least two synchronous audible signal.

53. The method of claim 47 wherein the at least two synchronous audible signals are periodic.

54. The method of claim 47 wherein the at least two audible signals are continuous.

55. The method of claim 46 wherein the visual signal is continuously emitted.

56. The method of claim 46 wherein the visual signal is periodically emitted.

57. An object locator system comprising:
a. a transmitter capable of transmitting a plurality of signals; and
b. a plurality of receivers, each adapted to be coupled to an object, wherein one receiver in the plurality emits a flashing light upon receiving a unique signal of the plurality of signals.

58. An system for aiding a hearing impaired user to locate an object comprising:
a. a transmitter configured to transmit a plurality of signals, the transmitter capable of emitting a two-tone audible signal; and
b. a plurality of receivers, each receiver capable of being attached to an object, wherein one receiver of the plurality emits a two-tone sound upon receiving a unique signal of the plurality of the signals.
